(19) United States
(12) Patent Application Publication
(10) Pub. No.: US 2010/0031565 A1
(43) Pub. Date: Feb. 11, 2010

(54) Branch support

(75) Inventor: Sheldon H. Beugen, Chicago, IL (US)

Correspondence Address: SHELDON H. BEUGEN, 1708 NORTH HUDSON STREET, CHICAGO, IL, 60614, US

(73) Assignee: SHELDON HOWARD BEUGEN, CHICAGO, IL (US)

(21) Appl. No.: 12/228,128

(22) Filed: Aug. 11, 2008

(51) Int. Cl. A01G 17/14; A01G 17/10

(52) U.S. Cl. 47/43

(57) ABSTRACT

One of the more common causes of plant rot and pest infestation is low-hanging branches and heavy blossomed stems lying on the ground, encouraging rot and fungus and providing pests a way to climb to the core of the plant or bush. The Branch Support Invention lifts these problem branches and stems and supports them safely.

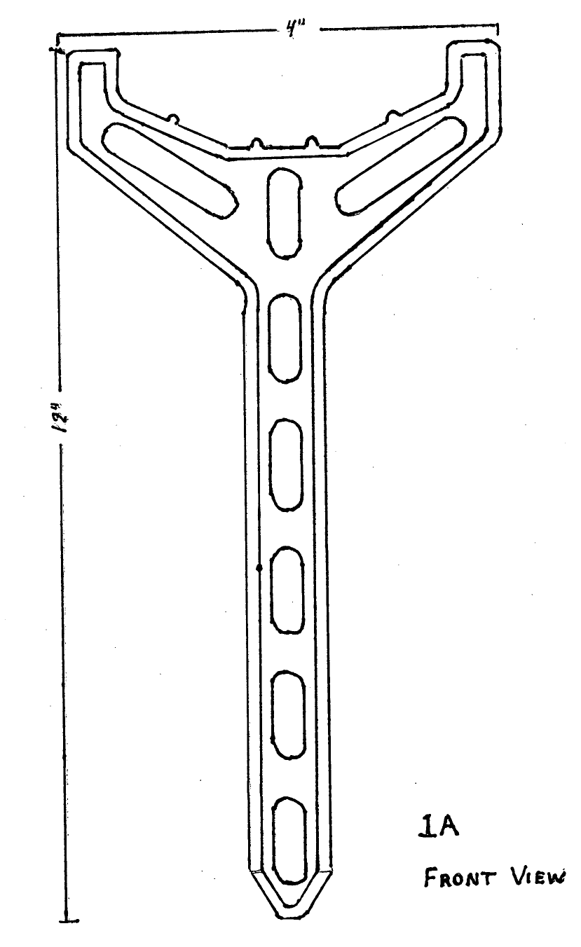

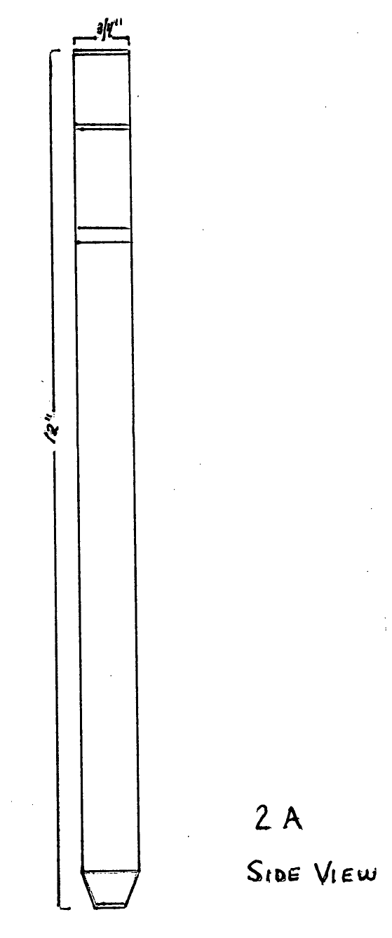

### BACKGROUND OF INVENTION

Gardeners and Landscapers have fought plant rot and pest infestation for hundreds of years. One of the more common causes of plant rot and pest infestation is low-hanging branches and heavy blossomed stems lying on the ground, encouraging rot and fungus and providing pests a way to climb to the core of the bush or plant. Until now, the only way to raise these branches off the ground has been to prop them up with rocks or bricks or bind them to wooden stakes which tend to rot, securing branches with wires or cord that can retard the normal growth of the branch, possibly cutting into the bark.

### SUMMARY OF INVENTION

The unique design of the Branch Support provides a solution for pest infestation and plant rot caused by branches or heavy flowering stems that lie on the ground because of their weight. The Branch Support is *an exaggerated “Y” shaped cradle designed to elevate and support the branch, without inhibiting the plant's normal growth progress. The branch resting area has a series of nubs which safely keep the branch from shifting, thus providing additional support. The base of the Support is tapered to permit easy placement in the ground. The height of the Support is changed simply by pushing the support deeper into the ground. The Branch Support is molded from recycled plastic materials, and is designed to support the weight of branches in all weather conditions. It can be especially useful in areas that experience heavy rainfalls or snowfalls and can help support branches that may be weak and prone to breaking. Because of the fabrication materials, the Support will not rot or crack as wood might after a year or two in the ground. The Branch Support is colored in earth tones to blend with typical garden coloration.

What I claim as my invention is a device to lift branches and flowering stems off the ground thus reducing the incidence of plant rot, fungus, and pest infestation.

1. Provides a solution for plant rot, fungus and pest infestation in plants and shrubs caused by branches or flowering stems that lie on the ground because of their weight or injury by raising them off the ground.

2. Improves air circulation at the base of the plant or shrub by raising branches off the ground.

3. Does not inhibit normal branch growth and development because the unique design allows branches to lie in the cradle without being wired or otherwise restrained.
